(19) United States
(12) Patent Application Publication
(10) Pub. No.: US 2019/0138943 A1
(43) Pub. Date: May 9, 2019

(54) COGNITIVE VISUAL CONVERSATION

(71) Applicant: INTERNATIONAL BUSINESS MACHINES CORPORATION, ARMONK, NY (US)

(72) Inventors: Rahul P. Akolkar, Austin, TX (US); Kristi A. Farinelli, Philadelphia, PA (US); Joseph L. Sharpe, Loveland, OH (US); Stefan Van Der Stockt, Austin, TX (US)

(21) Appl. No.: 15/807,264

(22) Filed: Nov. 8, 2017

(51) Int. Cl. G06N 99/00; G06N 5/02; G06F 17/30

(52) U.S. Cl. CPC G06N 99/005; G06F 17/3012; G06N 5/022

(57) ABSTRACT

The disclosed embodiments include a computer-implemented method executed by a cognitive system. In one embodiment, the computer-implemented method includes the step of receiving a first image as part of a visual communication session. The method identifies metadata associated with the first image. The method identifies objects and their surroundings depicted in the first image. The method identifies properties associated with the objects and their surroundings depicted in the first image. The method retrieves information associated with the objects and their surroundings depicted in the first image based on the metadata and the properties associated with the objects and their surroundings. The method interacts with a user based in part on the information associated with the objects and their surroundings depicted in the first image.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The present disclosure relates generally to cognitive digital assistant (CDA) systems. Today's CDAs, such as Apple's Siri® and Amazon's Alexa®, are programmed with artificial intelligence (AI), machine learning, and voice recognition technology. As the end user interacts with the digital assistant, the AI programming uses sophisticated algorithms to learn from the input of the user and become better at predicting the needs of the user. Tomorrow's digital assistants will be built with more advanced cognitive computing technologies which will allow a digital assistant to understand and perform more complex tasks.

### SUMMARY

As an example embodiment, a computer-implemented method is disclosed that includes the step of receiving a first image as part of a visual communication session. The method identifies metadata associated with the first image. The method identifies objects and their surroundings depicted in the first image. The method identifies properties associated with the objects and their surroundings depicted in the first image. The method retrieves information associated with the objects and their surroundings depicted in the first image based on the metadata and the properties associated with the objects and their surroundings. The method interacts with a user based in part on the information associated with the objects and their surroundings depicted in the first image.

Other embodiments and advantages of the disclosed embodiments are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a cognitive digital assistant system in accordance with various embodiments of the present disclosure.

FIG. 2 is a schematic diagram illustrating a visual communication module in accordance with various embodiments of the present disclosure.

FIG. 3 is a flowchart illustrating a process for providing a visual communication session in accordance with various embodiments of the present disclosure.

FIGS. 4A and 4B are images that may be received as part of a visual communication session in accordance with various embodiments of the present disclosure.

FIG. 5 is an image that may be received as part of a visual communication session in accordance with various embodiments of the present disclosure.

FIG. 6 is a block diagram of various hardware components of a cognitive digital assistant system in accordance with various embodiments of the present disclosure.

The illustrated figures are only exemplary and are not intended to assert or imply any limitation with regard to the environment, architecture, design, or process in which different embodiments may be implemented. Any optional component or steps are indicated using dash lines in the illustrated figures.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity, and the singular forms “a”, “an” and “the” are intended to include the plural forms as well, unless the context clearly indicates otherwise.

A module as referenced herein may comprise of software components such as, but not limited to, data access objects, service components, user interface components, application programming interface (API) components; hardware components such as electrical circuitry, processors, and memory; and/or a combination thereof. The memory may be volatile memory or non-volatile memory that stores data and computer executable instructions. The computer executable instructions may be in any form including, but not limited to, machine code, assembly code, and high-level programming code written in any programming language. The module may be configured to use the data to execute one or more instructions to perform one or more tasks.

The disclosed embodiments seek to improve cognitive digital assistant systems by enabling a visual means of communication that leverage cognitive capabilities to communicate intangible characteristics and preferences through photos, videos, or images rather than words. Advantages of the disclosed embodiments include enabling a user to converse with a cognitive agent through the use of images which often depict details that may not be fully expressed in words. In certain embodiments, the disclosed embodiments may provide recommendations of one or more products to the user based on one or more images. In certain embodiments, the disclosed embodiments may even provide beneficial services or information to the user based on the images that the user was not even aware of (e.g., financial or tax services and/or related upcoming events).

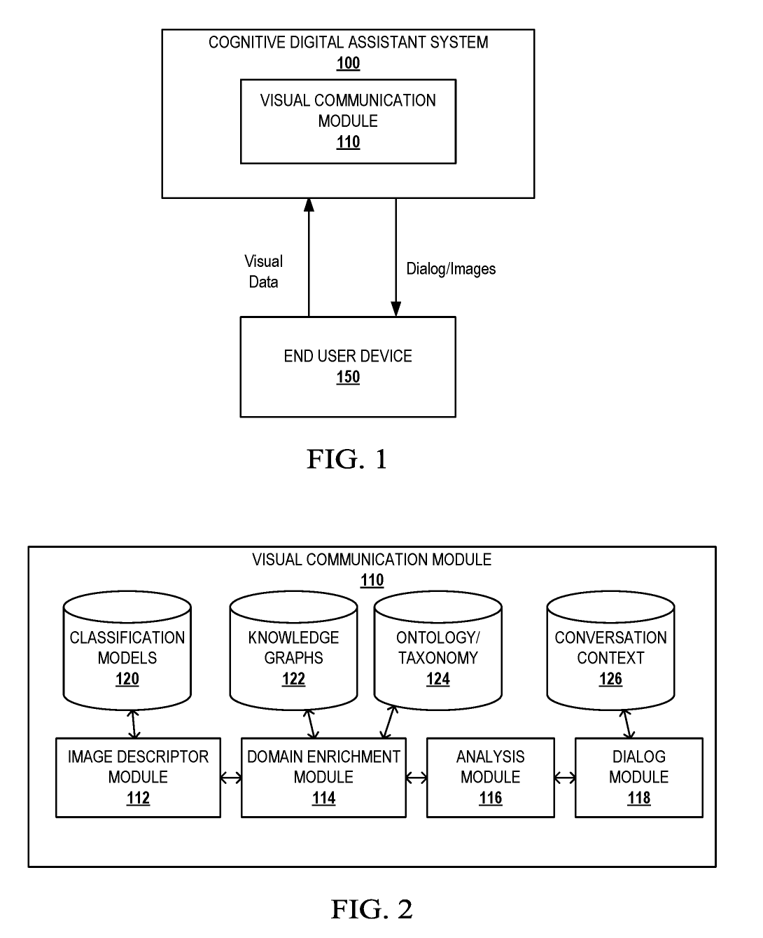

FIG. 1 is a schematic diagram illustrating a cognitive digital assistant system 100 in accordance with various embodiments of the present disclosure. The cognitive digital assistant system 100 is communicatively coupled to at least one end user device 150. As referenced herein, the term “communicatively coupled” means capable of sending and/or data over a communication link. In certain embodiments, communication links may also encompass internal communication between various components of a system and/or with an external input/output device such as a keyboard or display device. Additionally, the communication link may include both wired and wireless links, and may be a direct link or may comprise of multiple links passing through one or more communication network devices such as, but not limited to, routers, firewalls, servers, and switches. The network device may be located on various types of networks. A network as used herein means a system of electronic devices that are joined together via communication links to enable the exchanging of information and/or the sharing of resources. Non-limiting examples of networks include local-area networks (LANs), wide-area networks (WANs), and metropolitan-area networks (MANs). The networks may include one or more private networks and/or public networks such as the Internet. The networks may employ any type of communication standards and/or protocol.

The end user device 150 may be any type of electronic device that is able to send and receive information to and from the cognitive digital assistant system 100. In certain embodiments, the end user device 150 may be carried or worn by an end user. For example, in some embodiments, the end user device 150 may be a smart phone, a smart watch, electronic eyewear, mobile phone, or other user electronic devices. In other embodiments, end user device 150 may be an electronic device that sits on a desk, installed on a wall or ceiling surface, installed in a wall outlet, and/or may be integrated into a household item such as an appliance or a television. In certain embodiments, the end user device 150 includes memory, a processor, a microphone, an audio output component such as a speaker, and a network interface for communicating with the cognitive digital assistant system 100. In certain embodiments, the end user device 150 may also include a display or display interface for displaying information to a user. The end user device 150 may also include one or more input interfaces for receiving information from a user. In certain embodiments, the end user device 150 may include a camera for capturing images. An image as referenced herein may be a still image, a video, or any type of drawing or illustration.

In the depicted embodiment, the cognitive digital assistant system 100 includes a visual communication module 110 that is configured to enable a visual communication session. A visual communication session as referenced herein is defined as a communication session dialog between a cognitive digital assistant system (such as the cognitive digital assistant system 100) and end user device (such as the end user device 150) in which the cognitive digital assistant system may receive one or more images from the end user device as input to a dialog. The visual communication session enables a user to communicate information based on his surroundings or within an image that would be difficult for the user to adequately describe given the level of detail of his surroundings or the within the image. In various embodiments, the image may be captured in real-time with a camera device and/or may be retrieved from a local or remote data storage device. In some embodiments, the visual communication module 110 may be configured to receive a link, file address, network address, a universal resource locator, or other reference address to an image instead of the image itself. In one embodiment, a visual communication session starts with the visual communication module 110 receiving at least one image from the end user device 150 to initiate a dialog. The visual communication module 110 performs image analysis on the at least one image to determine various attributes about the image including identifying objects in the images and their surroundings as will be further described. In one embodiment, the visual communication module 110 may be configured to respond to the end user device 150 with one or more questions/requests. The one or more questions or requests from the visual communication module 110 may be in any form including audio, video, and textual formats. For example, the one or more questions or requests may be displayed on the end user device 150 or may be converted from text to speech for audio output on the end user device 150. The visual communication module 110 may receive as input to the dialog one or more additional images from the end user device 150 in response to the one or more questions/requests. The visual communication module 110 is configured to perform image analysis on the one or more additional images and may continue to converse with the end user device 150 in like manner until the communication session dialog terminates. In various embodiments, the communication session dialog may terminate when a user of the end user device 150 indicates that he/she is satisfied with the information provided to the user by the visual communication module 110 or if the cognitive digital assistant system 100 does not receive a response back from the user device 150 within a predetermined time. In various embodiments, the information provided to the user by the visual communication module 110 may be a recommendation for a product or a service. In some embodiments, the information provided to the user by the visual communication module 110 may be information that the visual communication module 110 has identified as being potentially important to the user based on the analysis of the objects in the image(s) and their surroundings.

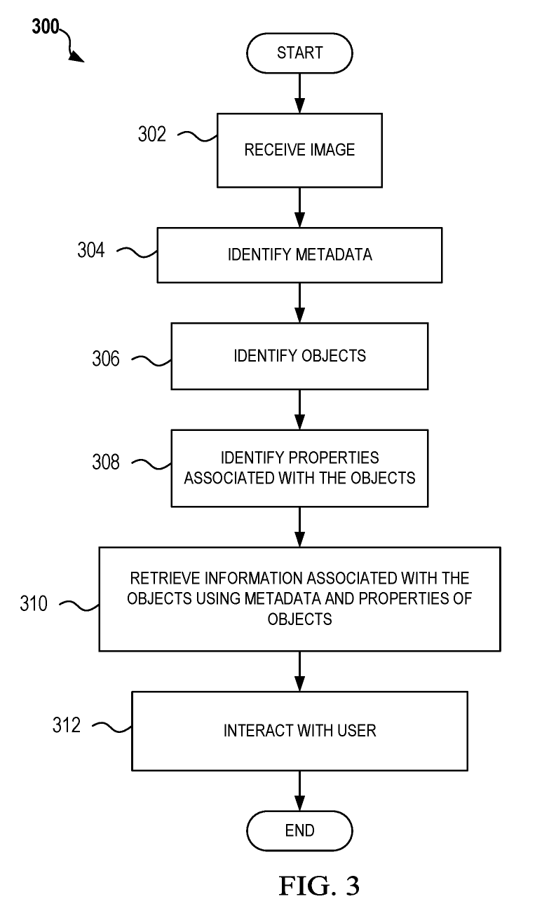

FIG. 2 is a schematic diagram illustrating the visual communication module 110 in accordance with various embodiments of the present disclosure. In the depicted embodiment, the visual communication module 110 includes an image descriptor module 112, a domain enrichment module 114, an analysis module 116, a dialog module 118, a classification models database 120, a knowledge graphs database 122, an ontology/taxonomy database 124, and a conversation context database 126. In one embodiment, the image descriptor module 112 is configured to extract metadata from an image and determine the objects in their surroundings depicted in an image. Image metadata is information pertaining to an image file that is embedded into an image file or contained in a separate file that is associated with the image. Image metadata may include details relevant to the image itself as well as information about its production. The image metadata may be generated automatically by the device capturing the image. In various embodiments, the image metadata may include location information identifying a location where the image was taken, time information indicating a date and time when the image was taken, device information identifying a device that took the image, user information identifying the user that took the image, and size information indicating a size and quality of the image. In various embodiments, the image descriptor module 112 may be configured to use one or more image classification models stored in classification models database 120 for performing image recognition to identify the objects and their surroundings in an image. The image classification models are trained using a plurality of images of different objects and environments. In one embodiment, each of the objects and their surroundings in an image are compared to images in the image classification model for identifying the object of their surroundings. In one embodiment, International Business Machines (IBM®) Watson Visual Recognition service may be used to analyze images for scenes, objects, faces, colors, food, and other subjects, and accurately tag and classify visual content using machine learning.

In one embodiment, the domain enrichment module 114 is configured to augment the identified objects and their surroundings with higher-level concepts using one or more knowledge graphs stored in the knowledge graphs database 122 and/or one or more ontology/taxonomy classification models stored in ontology/taxonomy database 124. The taxonomy classification model provides taxonomy relationships between various entities. Taxonomy is a simple hierarchical arrangement of entities. For example, a bug is an insect, and an insect is an animal. The ontology classification model provides ontology relationships between various entities. Ontology is a more complex variation of taxonomy. Besides having the hierarchical arrangement, ontology includes attributes of entities as well as the interrelationships between other entities. For example, a characteristics of an insect is that it has an exoskeleton. The ontology model may show the various types of insects and how they relate to another insect. A knowledge graph depicts a collection of entities where the types and properties have declared values, and where the relationships between them are mapped. As stated above, the domain enrichment module 114 is configured to augment the identified objects and their surroundings with higher-level concepts. As an example, in one embodiment, if an image includes a football, the domain enrichment module 114 may augment the identified football object with information related to the manufacturers of football, with information related to a local football team based on the metadata/location information of the image, and with information related to a price range for footballs from various outlets.

In one embodiment, the analysis module 116 is configured to analyze the augmented information and metadata for the various objects and their surroundings in the image to determine a best course of action in response to the received image. For instance, in various embodiments, the analysis module 116 may determine that the best course of action is providing a recommendation of a product and/or a service associated with the objects and their surroundings depicted in the first image. For example, if the image is a bedroom, the analysis module 116 may provide a recommendation of products such as furniture or bedding for the bedroom and/or the analysis module 116 may provide a recommendation for a particular paint color for the room and/or recommended painting services. In various embodiments, the analysis module 116 may request at least one additional image. For example, if the analysis module 116 requires additional information or a clearer image of a particular object or the surroundings to determine a best course of action, the analysis module 116 may send a request for the one or more additional images to the end user device 150 using the dialogue module 118. In one embodiment, the dialogue module 118 may be configured to interact with the end user device 150 in the form of an audio dialog, a visual dialog, a textual dialog, and/or any other forms of communication. In various embodiments, the dialogue module 118 may be configured to receive images, text, documents, files, or other types of input during the visual communication session rom the end user device 150. The analysis module 116 is configured to process the additional images or other various input data as described above for determining the information associated with the objects and their surroundings in the additional images. In various embodiments, the dialogue module 118 may be configured to retain the data regarding the visual communication session as part of the user profile of the user in the conversation context database 126.

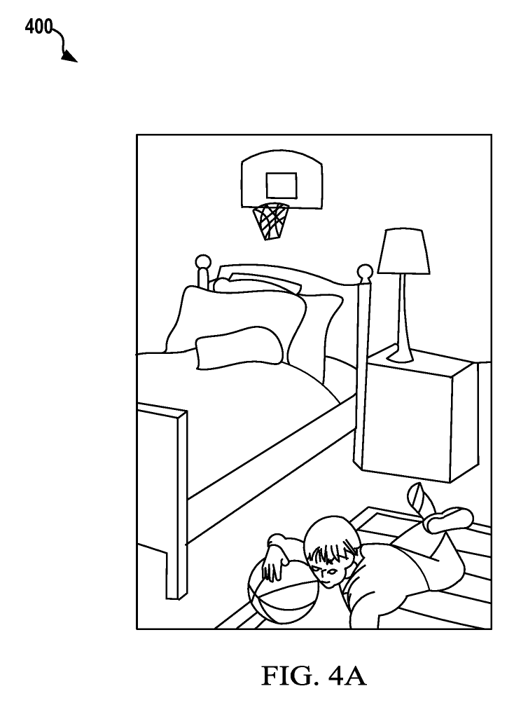

FIG. 3 is a flowchart illustrating a process 300 for providing a visual communication session in accordance with various embodiments of the present disclosure. The process 300 may be executed by a cognitive digital assistant system such as cognitive digital assistant system 100. Specifically, the process 300 may be implemented using computer executable instructions that are stored in memory of the cognitive digital assistant system and executed by a processor of the cognitive digital assistant system. The process 300 begins at step 302 by receiving at least one image as part of a visual communication session. The process 300 at step 304 processes the image to identify metadata associated with the image. The metadata may be extracted from embedded data in the image or may be extracted from a file associated with the image.

At step 306, the process 300 identifies the objects and their surroundings depicted in the image. The surroundings may include the environmental surroundings (e.g., the environmental surroundings may be a playground area, a farm, a lake, a wooded forest) and object surroundings related to other objects in the image (e.g., a pillow is located on a bed; the bed is located in a cabin).

At step 308, the process 300 identifies properties associated with the objects and their surroundings depicted in the image. For example, the process may identify a particular car model or even the year of a vehicle depicted in the image and that vehicle is on a race track. As another example, the process 300 may identify a particular bedroom is a nursery, or a child's bedroom, and may even identify whether it's a boy's bedroom or a girl's bedroom. In certain embodiments, the process 300 may identify a size and dimensionality as an attribute of the image or objects within the image. For example, when identifying a room, the process 300 may determine the size of the room and appropriately sized furniture for the room. As another example, the process 300 may analyze an input of an image of a boat and be able to discern a model boat from a remote control toy boat, a 20 foot sailboat, or a cruise liner boat.

At step 310, the process 300 retrieves information associated with the objects and their surroundings depicted in the image based on the metadata and the properties associated with the objects and their surroundings. For example, the process may retrieve information related to the cost, performance, and other information related to the particular car model identified in the image. As another example, the process may retrieve information related to a driving experience where a user may experience driving the particular car model on a race track. Still, in some embodiments, the process may retrieve information related to an event associated with cars (e.g., “I see that you like exotic cars, there is a car show near your location next week.”).

At step 312, the process 300 interacts with the user/end user device based on the information associated with the objects and their surroundings depicted in the image. For example, the process 300 may provide a recommendation for a particular product or service based on the information associated with the objects and their surroundings depicted in the image. The process 300 may also request additional information from the user such as, but not limited to, one or more additional images. The additional images are then processed in accordance with the process 300. In certain embodiments, the process 300 may ask the user particular questions to determine a best course of action and/or recommendation for the user. For instance, if an image contains numerous objects, the process 300 may request that the user indicate the object that the user is interested in or crop the image to focus one or more particular obj ects.

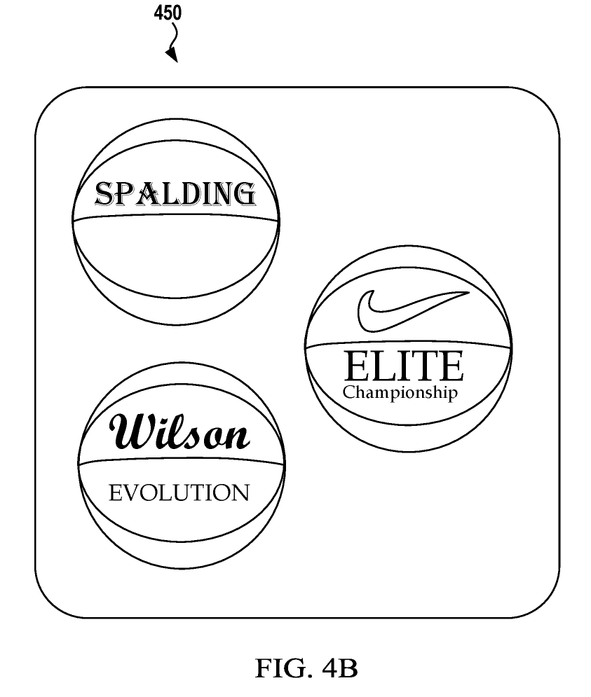

FIGS. 4A and 4B are examples of images that may be received as part of a visual communication session in accordance with various embodiments of the present disclosure. FIG. 4A depicts an image 400 of a boy with a basketball lying on the floor of his bedroom. The image 400 is uploaded or sent to the cognitive digital assistant system 100. In one embodiment, the cognitive digital assistant system 100 identifies the following objects, surroundings, and attributes of the image 400: “basketball”, “bed”, “football”, “model-car”, “blue”, “red”, and “bedroom.” In one embodiment, the cognitive digital assistant system 100′s ontology/taxonomy augments these fields with higher-level concepts like “sports” and “boys bedroom.” The cognitive digital assistant system 100 performs analysis using the information about the room and style and inventory to assemble a next best action. In one embodiment, the system responds with “I see a boy's room with traditional colors. Would you like to explore some furniture or drapes? Here are some ideas.” In one embodiment, the user may respond with a second photo of another bedroom to provide additional details about the bedroom. The cognitive digital assistant system 100 processes the new photo and adds features and high-level semantic evidence to the working set of descriptors. In certain embodiments, some descriptors will be reinforced (like “bedroom” and “sports”) and some refinement may occur (like “color pallet”). Using the additional image information, the cognitive digital assistant system 100 may subsequently recommend different products such as those more related to the particular bedroom in the image 400. For example, in one embodiment, the cognitive digital assistant system 100 may ask “I see burnt orange and cream colors. Are you University of Texas themed?” If the user responds in the affirmative, the cognitive digital assistant system 100 may be configured to recommend University of Texas themed bedroom linens and decoration materials.

If the user is not interested in University of Texas themed products, but instead responds that she is more interested in the basketball that the boy is holding, the user may additionally or in lieu of the verbal response upload the image 450 shown in FIG. 4B to indicate her interest in the basketball. In one embodiment, the cognitive digital assistant system 100 parses and analyzes the image 450. The cognitive digital assistant system 100 adds and reinforces descriptor tags. The cognitive digital assistant system 100 then detects higher-level semantic content and reinforces/filters the existing semantic categories. In the depicted embodiment, the cognitive digital assistant system 100 may determine that the best course of action is to recommend or provide links to purchase various types of basketball (e.g., Nike® indoor basketball, Spalding® indoor basketball, and Wilson® evolution basketball). In one embodiment, the user clicks buy on the Spalding Indoor Basketball. The cognitive digital assistant system 100 may optionally be configured to complete the buy request for the user. For example, in certain embodiments, the cognitive digital assistant system 100 may store the user's credit card information, mailing address, and shipping preferences. The cognitive digital assistant system 100 then completes the purchase request from a particular vendor for the user.

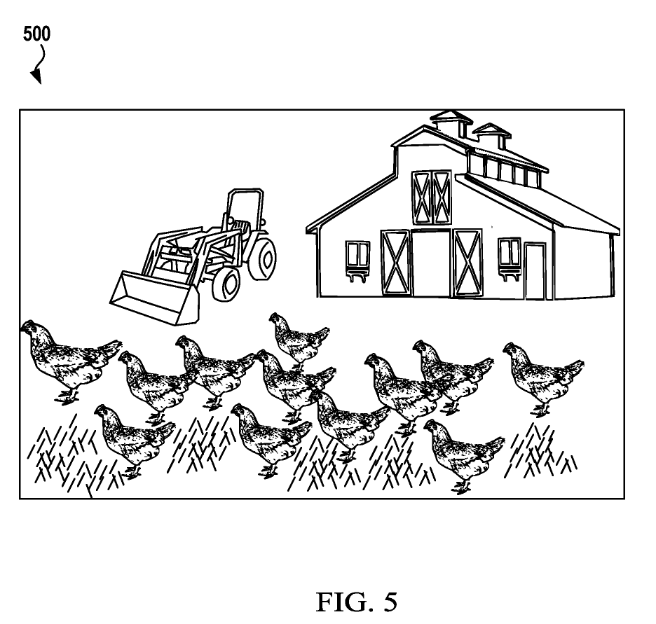

FIG. 5 is another image 500 that may be received as part of a visual communication session in accordance with various embodiments of the present disclosure. In one embodiment, the cognitive digital assistant system 100 may receive the image 500 to initiate a visual communication session. In one example embodiment, the cognitive digital assistant system 100 extracts the geolocation tag of the image 500 and identifies that the property shown in the image 500 is zoned as agricultural. The cognitive digital assistant system 100 uses image recognition to identify the objects and surroundings in the image 500 such as the buildings, equipment, and animals located on image 500. In one embodiment, based on the identified objects and metadata information, the cognitive digital assistant system 100 may use domain enrichment to map the identified objects to the hypernyms (e.g., Farm, Equipment Container) and determine that the image relates to an agricultural property. In one embodiment, the cognitive digital assistant system 100 may be configured to retrieve services or products related to an agricultural property. For example, in one embodiment, the cognitive digital assistant system 100 may be configured with the tax codes and credits related to an agricultural property or to perform a lookup of the tax codes and credits related to an agricultural property. For example, in one embodiment, the cognitive digital assistant system 100 may inform the user that there is a tax credit for having chickens on an agricultural property. In certain embodiments, the cognitive digital assistant system 100 may even calculate the tax credit based on the number of chickens in the image and the size of the agricultural property (e.g., the size of the agricultural property may be determined by querying county records based on the determined location (geo-tag) of the image 500). In certain embodiments, the cognitive digital assistant system 100 may be configured to request additional images that may provide the user with additional tax credits. For example, in one embodiment, the cognitive digital assistant system 100 may respond: “I see a barn. Can you show me what's in the barn?” If the user responds by uploading an image showing the interior of the barn, the cognitive digital assistant system 100 performs image recognition to identify the equipment within the barn. The cognitive digital assistant system 100 may use domain enrichment to map a tractor, plow, and truck as Farm Machinery. Based on the analysis, the cognitive digital assistant system 100 may determine the following tax credit opportunities: Farm machinery tax credits and Chicken farming tax credits. The described tax service is just one example of the various benefits that may be provided by the cognitive digital assistant system 100. For example, in certain embodiments, the cognitive digital assistant system 100 may be configured to determine that based on your location and current crop growth and expected weather pattern, the crops should be harvested or covered to prevent crops from dying by a certain date.

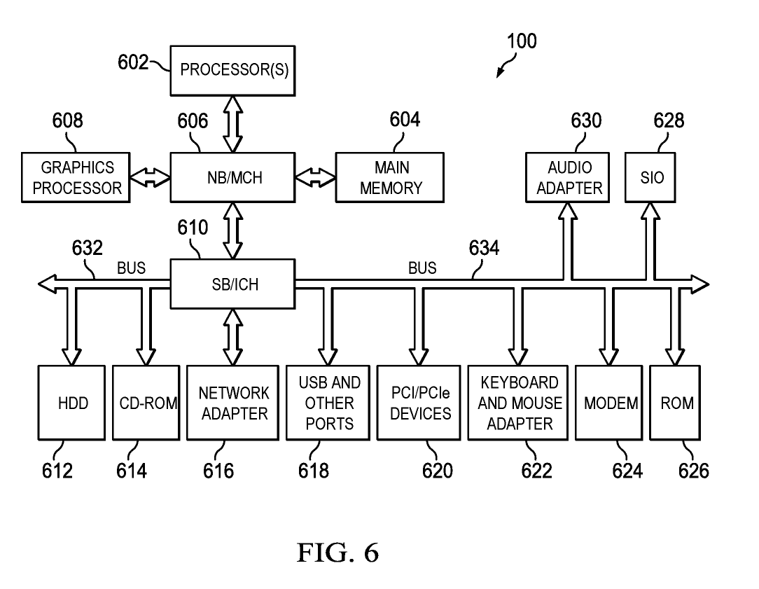

FIG. 6 is a block diagram of various hardware components of the cognitive digital assistant system 100 in accordance with an embodiment. Although FIG. 6 depicts certain basic components of the cognitive digital assistant system 100, the disclosed embodiments may also be implemented in very advanced systems such as an IBM® Power 750 servers or the IBM Watson® supercomputer, which employs a cluster of ninety IBM® Power 750 servers, each of which uses a 3.5 GHz POWER7 eight-core processor, with four threads per core. Additionally, certain embodiments of the cognitive digital assistant system 100 may not include all hardware components depicted in FIG. 6. Similarly, certain embodiments of the cognitive digital assistant system 100 may include additional hardware components that are not depicted in FIG. 6.

In the depicted example, the cognitive digital assistant system 100 employs a hub architecture including north bridge and memory controller hub (NB/MCH) 606 and south bridge and input/output (I/O) controller hub (SB/ICH) 610. Processor(s) 602, main memory 604, and graphics processor 608 are connected to NB/MCH 606. Graphics processor 608 may be connected to NB/MCH 606 through an accelerated graphics port (AGP). A computer bus, such as bus 632 or bus 634, may be implemented using any type of communication fabric or architecture that provides for a transfer of data between different components or devices attached to the fabric or architecture.

In the depicted example, network adapter 616 connects to SB/ICH 610. Audio adapter 630, keyboard and mouse adapter 622, modem 624, read-only memory (ROM) 626, hard disk drive (HDD) 612, compact disk read-only memory (CD-ROM) drive 614, universal serial bus (USB) ports and other communication ports 618, and peripheral component interconnect/peripheral component interconnect express (PCI/PCIe) devices 620 connect to SB/ICH 610 through bus 632 and bus 634. PCI/PCIe devices 620 may include, for example, Ethernet adapters, add-in cards, and PC cards for notebook computers. PCI uses a card bus controller, while PCIe does not. ROM 626 may be, for example, a flash basic input/output system (BIOS). Modem 624 or network adapter 616 may be used to transmit and receive data over a network.

HDD 612 and CD-ROM drive 614 connect to SB/ICH 610 through bus 634. HDD 612 and CD-ROM drive 614 may use, for example, an integrated drive electronics (IDE) or serial advanced technology attachment (SATA) interface. Super I/O (SIO) device 628 may be connected to SB/ICH 610. In some embodiments, HDD 612 may be replaced by other forms of data storage devices including, but not limited to, solid-state drives (SSDs).

An operating system runs on processor(s) 602. The operating system coordinates and provides control of various components within the cognitive digital assistant system 100 in FIG. 6. Non-limiting examples of operating systems include the Advanced Interactive Executive (AIX®) operating system or the Linux® operating system. Various applications and services may run in conjunction with the operating system. For example, in one embodiment, International Business Machines (IBM)® DeepQA software, which is designed for information retrieval that incorporates natural language processing and machine learning, is executed on cognitive digital assistant system 100.

The cognitive digital assistant system 100 may include a single processor 602 or may include a plurality of processors 602. Additionally, processor(s) 602 may have multiple cores. For example, in one embodiment, cognitive digital assistant system 100 may employ a large number of processors 602 that include hundreds or thousands of processor cores. In some embodiments, the processors 602 may be configured to perform a set of coordinated computations in parallel.

Instructions for the operating system, applications, and other data are located on storage devices, such as one or more HDD 612, and may be loaded into main memory 604 for execution by processor(s) 602. For example, in various embodiments, HDD 612 may store one or more images, historical data on visual communication sessions, a user profile, and computer executable instructions for maintaining a visual communication session dialog as disclosed herein. In some embodiments, additional instructions or data may be stored on one or more external devices. The processes for illustrative embodiments of the present invention may be performed by processor(s) 602 using computer usable program code, which may be located in a memory such as, for example, main memory 604, ROM 626, or in one or more peripheral devices 612 and 614.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Unless specifically indicated, any reference to the processing, retrieving, and storage of data and computer executable instructions may be performed locally on an electronic device and/or may be performed on a remote network device. For example, data may be retrieved or stored on a data storage component of a local device and/or may be retrieved or stored on a remote database or other data storage systems. As referenced herein, the term database or knowledge base is defined as collection of structured or unstructured data. Although referred to in the singular form, the database may include one or more databases, and may be locally stored on a system or may be operatively coupled to a system via a local or remote network. Additionally, the processing of certain data or instructions may be performed over the network by one or more systems or servers, and the result of the processing of the data or instructions may be transmitted to a local device.

It should be apparent from the foregoing that the disclosed embodiments have significant advantages over current art. As an example, the disclosed embodiments enable a user to converse with a cognitive agent through the use of images which often depict details that may not be fully expressed in words. In certain embodiments, the disclosed embodiments may provide recommendations of one or more products to the user based on one or more images. In certain embodiments, the disclosed embodiments may even provide beneficial services or information to the user based on the images that the user was not even aware of or requesting.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. For example, although the above disclosed embodiments are described for use with the English language, the disclosed embodiments may be employed for any language.

Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method executed by a cognitive system, the computer-implemented method comprising:
receiving a first image as part of a visual communication session;
identifying metadata associated with the first image;
identifying objects and their surroundings depicted in the first image;
identifying properties associated with the objects and their surroundings depicted in the first image;
retrieving information associated with the objects and their surroundings depicted in the first image based on the metadata and the properties associated with the objects and their surroundings; and
interacting with a user based in part on the information associated with the objects and their surroundings depicted in the first image.

2. The computer-implemented method of claim 1, further comprising applying at least one of an ontology and taxonomy higher-level concept to the objects depicted in the first image.

3. The computer-implemented method of claim 1, wherein identifying properties associated with the objects and their surroundings depicted in the first image comprises recognizing environments, spatial properties, features, style, and colors.

4. The computer-implemented method of claim 1, wherein interacting with the user based in part on the information associated with the objects and their surroundings depicted in the first image comprises requesting at least one additional image, wherein the computer-implemented method further processes the at least one additional image in a manner same as the first image, and wherein interacting with the user is based in part on the information associated with the objects and their surroundings depicted in the first image and in the at least one additional image.

5. The computer-implemented method of claim 1, wherein interacting with the user based in part on the information associated with the objects and their surroundings depicted in the first image comprises providing a recommendation of at least one of a product and a service associated with the objects and their surroundings depicted in the first image.

6. The computer-implemented method of claim 1, further comprising retaining data regarding the visual communication session as part of a user profile of the user.

7. The computer-implemented method of claim 6, wherein interacting with the user is based in part on the user profile of the user.

8. The computer-implemented method of claim 1, wherein the metadata associated with the first image comprises location information and time information of where and when the first image was taken.

9. The computer-implemented method of claim 1, wherein interacting with the user based in part on the information associated with the objects and their surroundings depicted in the first image comprises providing financial information that may be beneficial to the user.

10. The computer-implemented method of claim 1, wherein interacting with the user based in part on the information associated with the objects and their surroundings depicted in the first image may be in the form of an audio dialog, a visual dialog, and a textual dialog.

11. A cognitive system configured to provide a visual communication session, the cognitive system comprising memory configured to store computer executable instructions, a processor configured to execute the computer executable instructions to:
receive a first image as part of the visual communication session;
identify metadata associated with the first image;
identify objects and their surroundings depicted in the first image;
identify properties associated with the objects and their surroundings depicted in the first image;
retrieve information associated with the objects and their surroundings depicted in the first image based on the metadata and the properties associated with the objects and their surroundings; and
interact with a user based in part on the information associated with the objects and their surroundings depicted in the first image.

12. The cognitive system of claim 11, further comprising applying at least one of an ontology and taxonomy higher-level concept to the objects depicted in the first image.

13. The cognitive system of claim 11, wherein interacting with the user based in part on the information associated with the objects and their surroundings depicted in the first image comprises requesting at least one additional image, wherein the processor further executes the computer executable instructions to process the at least one additional image in a manner same as the first image, and wherein interacting with the user is based in part on the information associated with the objects and their surroundings depicted in the first image and in the at least one additional image.

14. The cognitive system of claim 11, wherein interacting with the user based in part on the information associated with the objects and their surroundings depicted in the first image comprises providing a recommendation of at least one of a product and a service associated with the objects and their surroundings depicted in the first image.

15. The cognitive system of claim 14, wherein the processor is configured to further execute instructions to retain data regarding the visual communication session as part of a user profile of the user, and wherein interacting with the user is based in part on the information associated with the objects and their surroundings depicted in the first image and the user profile of the user.

16. The cognitive system of claim 14, wherein interacting with the user based in part on the information associated with the objects and their surroundings depicted in the first image comprises informing the user of an event.

17. A computer program product for providing a visual communication session, the computer program product comprising a computer readable storage medium having program instructions embodied therewith, the program instructions executable by a processor of a system to cause the system to:
receive a first image as part of the visual communication session;
identify metadata associated with the first image;
identify objects and their surroundings depicted in the first image;
identify properties associated with the objects and their surroundings depicted in the first image;
retrieve information associated with the objects and their surroundings depicted in the first image based on the metadata and the properties associated with the objects and their surroundings; and
interact with a user based in part on the information associated with the objects and their surroundings depicted in the first image.

18. The computer program product of claim 17, wherein the program instructions executable by the processor further includes program instructions for applying at least one of an ontology and taxonomy higher-level concept to the objects depicted in the first image.

19. The computer program product of claim 17, wherein interacting with the user based in part on the information associated with the objects and their surroundings depicted in the first image comprises requesting at least one additional image, wherein the program instructions executable by the processor further includes program instructions to process the at least one additional image in a manner same as the first image, and wherein interacting with the user is based in part on the information associated with the objects and their surroundings depicted in the first image and in the at least one additional image.

20. The computer program product of claim 17, wherein interacting with the user based in part on the information associated with the objects and their surroundings depicted in the first image comprises providing a recommendation of at least one of a product and a service associated with the objects and their surroundings depicted in the first image.
